(19) United States
(12) Patent Application Publication
(10) Pub. No.: US 2007/0112663 A1
(43) Pub. Date: May 17, 2007

(54) Operating system and method for use in auction service based upon lowest bid price

(76) Inventor: Chaiil Jang, Gyeonggi-do (KR)

Correspondence Address: BACON & THOMAS, PLLC, 625 SLATERS LANE, FOURTH FLOOR, ALEXANDRIA, VA, 22314, US

(21) Appl. No.: 10/583,446

(22) PCT Filed: Jan. 17, 2004
(86) PCT No.: PCT/KR04/00078

§ 371 Date: Jun. 19, 2006

(30) Foreign Application Priority Data
Dec. 17, 2003 (KR) 10-2003-0092676

(51) Int. Cl. G06Q 40/00

(52) U.S. Cl. 705/37

(57) ABSTRACT

The present invention notifies all buyers joining an auction of bid prices offered thereby in real time, such that an auction operator's unlawful operation can be disabled, and the probability of a successful bid can be increased by a strategic plan of a buyer joining the auction, not by chance or good luck.

### TECHNICAL FIELD

The present invention relates to an operating system and method for use in an auction service based upon the lowest bid price, and more particularly to an operating system and method for use in an auction service based upon the lowest bid price that can provide bid information to all buyers joining an auction in real time while limiting a bidding time to a relatively short time so that fair bidding can be performed, and that can allow a person to adjust his/her bid price and join the auction with viewing bid information of other persons provided in real time.

### BACKGROUND ART

Conventionally, products, etc. are traded using a virtual space such as the Internet. In particular, a buyer can buy products at a cheap price, and a seller can sell the products at an expensive price, through a trade method of an auction or reverse auction.

The auctions are classified into an English auction and a Dutch auction according to product sale types. The English auction widely used is an auction for setting the deadline time, generally increasing a product price from the lowest price, and deciding a person offering the highest bid price to be a successful bidder.

In the Dutch auction, the bid price is descending from the highest price, and a person desiring to buy goods without an end date is decided to be a successful bidder as a buyer.

On the other hand, another auction includes an online reverse auction. In the online reverse auction, a bidder offering the lowest bid price can be decided to be a successful bidder as a supplier when a buyer for membership or goods offers purchase requirements.

Here, a subject of bidding the price in the English and Dutch auctions is a buyer, while a subject of bidding the price in the reverse auction is a seller.

The bid price descends from the highest price in the English auction, while the bid price ascends from the lowest price in the reverse and Dutch auctions.

In the English auction and the reverse auction, a client of the auction designates an auction end time in advance. However, because the auction end time is not separately designated in the Dutch auction, the auction end time means the time point when a buyer indicates a buying decision for goods.

On the other hand, the recent auction method is not an auction method based upon the highest bid price or original auction method. That is, an auction operating method based upon the lowest bid price is being performed to decide only one bidder offering the lowest bid price to be a successful bidder. Furthermore, the auction method based upon the lowest bid price is not an original auction or reverse auction in that it is not a method for deciding a bidder offering the highest bid price (in the conventional auction method) or deciding a bidder offering the lowest bid price (in the reverse auction method) to be a successful bidder. In the auction method based upon the lowest bid price, only one bidder offering the lowest bid price is decided to be the successful bidder.

Because one bidder cannot identify bid information of other bidders during a bid time, as the current auction method based upon the lowest bid price discloses bid information after the bid end time or the bid information is disclosed after a successful bidder has been decided, it is difficult for the bidder to determine an optimum bid price. In the case that the bid information is not disclosed in the bid time, the bid information can be used through an unlawful program manipulation or hacking before the successful bidder is disclosed, and the successful bidder can be decided by chance or luck.

### DISCLOSURE OF THE INVENTION

### TECHNICAL SUBJECTS TO BE SOLVED BY THE INVENTION

Therefore, the present invention has been made in view of the above problem, and it is one object of the present invention to provide a new operating system and method for use in an auction service based upon the lowest bid price.

It is another object of the present invention to provide an operating system and method for use in an auction service based upon the lowest bid price that can notify all buyers joining an auction of bid prices offered thereby in real time and allow all buyers to identify the bid information of other bidders, such that an auction operator's unlawful operation can be disabled and fair bid competition can be accomplished.

It is yet another object of the present invention to provide an operating system and method for use in an auction service based upon the lowest bid price that can limit a bidding time to a relatively short time and allow bid information of other bidders provided in real time to be identified, such that a bid strategic plan can be made on the basis of the identified information and a bidder can strategically join the auction service based upon the lowest bid price.

Solution

In accordance with one aspect of the present invention, the above and other objects can be accomplished by the provision of an auction service operating system based upon a lowest bid price, the auction service operating system being connected to a plurality of buyer terminals through at least one network and deciding one buyer offering the lowest bid price within a range between predetermined highest and lowest prices on a product to be a successful bidder for a predetermined time, comprising: a goods information database for storing goods information containing highest and lowest prices according to goods codes in an auction; a bid information database for storing bid information containing bid price and bidder information according to the goods codes; a bid registration part for carrying out a bid registration process by storing received bid prices in the bid information database when the bid prices are provided from the buyer terminals; and a successful bid process part for retrieving the lowest bid price from the bid information about a specific product stored in the bid information database, and deciding a buyer offering the lowest bid price to be a successful bidder if the lowest bid price is contained between the predetermined highest and lowest prices, wherein the bid prices offered by buyers are disclosed for a predetermined bid time.

In accordance with another aspect of the present invention, the above and other objects can be accomplished by the provision of an auction service operating method based upon a lowest bid price in a system being connected to a plurality of buyer terminals through at least one network and deciding one buyer offering the lowest bid price within a range between predetermined highest and lowest prices on a product to be a successful bidder for a predetermined time, comprising the steps of: (a) allowing buyers (or bidders) to select an auction product and to access the system; (b) allowing the buyers to offer bid prices within the predetermined highest and lowest prices; and (c) when a predetermined bid time expires, deciding a buyer (or bidder) offering the lowest bid price to be a successful bidder, wherein the bid prices offered by the buyers are disclosed for the bid time.

Preferably, the auction service operating method based upon the lowest bid price further comprises the step of: when only one bidder offering the lowest bid price is not present at the step (c), carrying out a retrieving operation to determine whether at least two bidders offering the lowest bid price are present, and deciding one of the at least two bidders first offering the lowest bid price to be the successful bidder.

### ADVANTAGEOUS EFFECTS

An auction method of the present invention notifies all buyers joining an auction of bid prices offered thereby in real time and allows all buyers to identify the bid information of other bidders, such that an auction operators unlawful operation can be disabled, and the probability of a successful bid can be increased by a strategic plan of a buyer joining the auction, not by chance or luck.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram illustrating the architecture of an auction service operating system in accordance with an embodiment of the present invention;

FIG. 2 is an explanatory view illustrating a process for operating an auction in the auction service operating system in accordance with an embodiment of the present invention;

FIG. 3 is a flowchart illustrating a process for registering bid information in an auction service operating method in accordance with an embodiment of the present invention; and

FIG. 4 is a flowchart illustrating a process for deciding a successful bidder in the auction service operating method in accordance with an embodiment of the present invention.

### BEST MODE FOR CARRYING OUT THE INVENTION

Now, preferred embodiments of the present invention will be described in detail with reference to the annexed drawings.

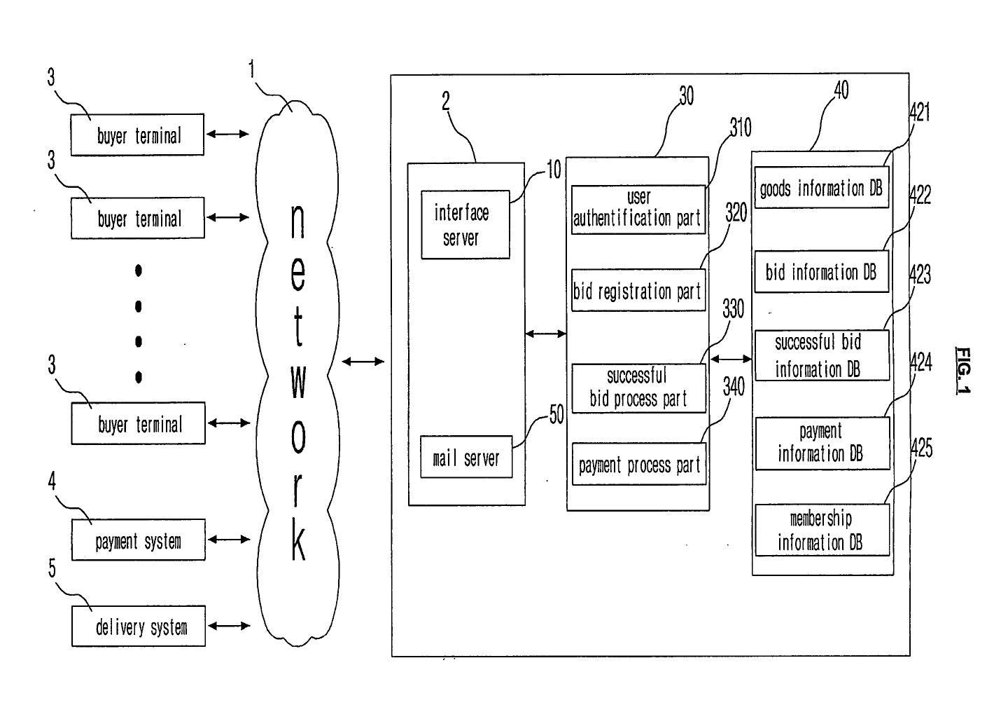

FIG. 1 is a schematic diagram illustrating the architecture of an auction service operating system based upon the lowest bid price in accordance with an embodiment of the present invention. As shown in FIG. 1, the auction service operating system based upon the lowest bid price in accordance with the embodiment of the present invention includes a mediation system 2 connected to a network 1, a plurality of buyer terminals 3, a payment system 4, and a delivery system 5.

The buyer terminals 3 are connected to the mediation system 2 through the network 1, and are communication devices capable of performing trade. For example, the buyer terminals 3 can use various communication devices such as a personal computer (PC), a personal digital assistant (PDA), a mobile communication terminal, an Internet accessible TV, etc.

The mediation system 2 connected to the buyer terminals 3 through the network 1 allows a bidder to purchase specific goods through a bid. The mediation system 2 includes an interface server 10 for a connection and information exchange through the network 1, a process server 30 for processing an auction procedure, a database server 40 for storing a plurality of information units, and a mail server 50.

The interface server 10 can be connected to the plurality of terminals 3 through the networks 1 and more particularly through the Internet, the wireless Internet or etc. The interface server 10 performs a conversion process so that various information units provided through the process server 30 can be appropriate for a communication standard, and provides a result of the conversion process to the plurality of terminals 3. Furthermore, the interface server 10 receives information transmitted from the terminals 3 through the network 1 and provides the received information to the process server 30. The interface server 10 can include a common gateway interface (CGI) for exchanging information with a web server or another system, etc. The mail server 50 communicates an electronic mail with each terminal 3 through the network 1.

The database server 40 includes a goods information database 421, a bid information database 422, a successful bid information database 423, a payment information database 424 and a membership information database 425.

The goods information database 421 stores information of all goods that can be traded through the mediation system 2. For example, the good information database 421 stores goods type information, manufacturer information, the highest and lowest prices set by an auction system operator, goods characteristics, etc. various goods information units such as a bid date and time, delivery information (containing delivery system information necessary for delivering goods, a delivery fee, etc.), etc., corresponding to goods codes assigned to the goods. These goods can be classified on a category-by-category basis, and information of the classified goods is stored. The classification can be performed at a plurality of steps according to each category. Furthermore, the existence of a bid fee and an amount of the bid fee are designated, and the bid fee is selectively assigned according to the goods. Here, the price is designated to the very small price so that the highest price on the goods can be 10% to 1% less than a consumer price. Furthermore, the lowest price can be set from 1 won to approximately 1% of a consumer price. The above-described prices are not limited. On the other hand, the goods information database contains information indicative of a unit of a bid price on goods (e.g., a unit of 1 cent, 2 cents, 10 cents or 1 United States dollar (USD), etc.).

The bid information database 422 stores bid information of buyers and more particularly their bid prices through the various networks 1. The bid information database 422 can store the bid information containing, for example, a purchase identification name (a buyer identity or identifier (ID), a resident registration number or etc.), a bid price, a bid date, a buyer's payment information (a credit card number, a bank account number or etc.), the number of bids of the buyer associated with corresponding goods, information of a contact place, etc., according to each goods code.

The successful bid information database 423 stores successful bid information of a successful bidder among a plurality of buyers on a goods-by-goods basis. For example, the successful bid information database 423 can store information indicative of a buyer name, a successful bid price, a delivery place, a delivery date, etc., corresponding to each goods code.

The payment information database 424 can store payment information, for example, an amount of payment (a bid fee for joining a bid, a purchase price on goods in case of a successful bid, etc.), a payment date, the existence of payment, etc., on a buyer-by-buyer basis.

The membership information database 425 stores information of buyers registered as members capable of performing trade through the mediation system 2. For example, the membership information database 425 stores a login ID, a password, an electronic mail address, a contact place, payment information, etc. Although the buyers do not separately input their information, payment, etc. can be automatically processed on the basis of stored information so that the buyers can join a bid. In accordance with the embodiment of the present invention, unregistered as well as registered buyers can also join the bid.

The process server 30 for carrying out a bid process and a successful bid process on the basis of the information stored in the database server 40 includes a user authentication part 310, a bid registration part 320, a successful bid process part 330 and a payment process part 340.

The user authentication part 310 performs membership registration and authentication processes for the plurality of buyers. The bid registration process part 320 carries out a corresponding process so that the buyers being members and nonmembers can perform a bid on specific goods through the network 1. The bid registration part 320 provides various goods information units stored in the goods information database 421 to the buyer terminals 3. The bid registration part 320 stores, in the bid information database 422, bid information of the buyers according to the specific goods and more particularly bid information containing bid prices of the buyers, discloses the bid information to all buyers, and carries out a bid registration process.

When the bid has been completed, the successful bid process part 330 selects a successful bidder according to each goods on the basis of a plurality of bid information units stored in the bid information database 422, and decides only one bidder offering the lowest bid price to be the successful bidder.

The payment process part 340 is interworked with the payment system 4 on the basis of the payment information of the buyers, processes the payment on the goods on the basis of the bid fee and the successful bid price, and stores a result of the payment process in the payment information database 424.

In accordance with the embodiment of the present invention, the respective components of the process server 30 operate therein, but this is not limited. Each component of the process server 30 can be implemented as an independent server so that a corresponding function can be processed. Also, the databases 421 to 425 are not limited as described above.

An operating method for use in an auction service based upon the lowest bid price in accordance with the present invention will be described on the basis of the system constituted as described above.

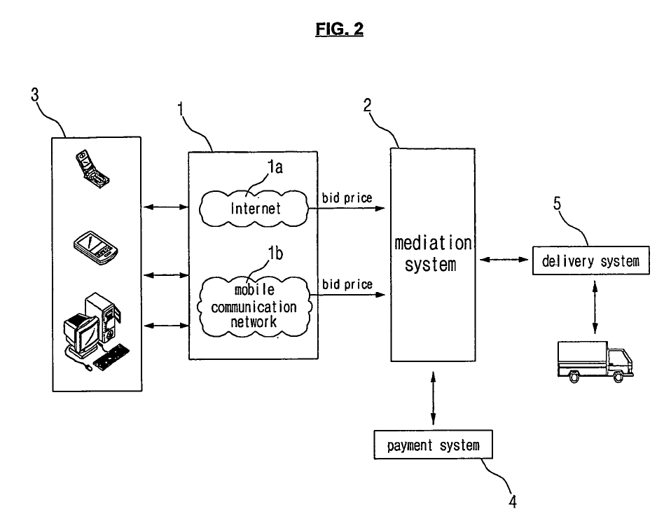

FIG. 2 is an explanatory view illustrating a process for operating an auction in the auction service operating system in accordance with an embodiment of the present invention. As shown in FIG. 2, a buyer in the auction service operating system can access a mediation system 2 using a computer or mobile communication terminal 3 in accordance with the embodiment of the present invention. The buyer offers a bid price on a product through the Internet or mobile communication network 1. The mediation system 2 decides the lowest bid price offered by only one bidder among a plurality of bidders to be a successful bid price, performs the payment on a corresponding product through a payment system 4, and enables a delivery system 5 to deliver a product based upon the successful bid and payment. On the other hand, bid price and buyer information associated with a buyer are disclosed to other all buyers while the biding is performed. For example, the bid information associated with a bid price, a buyer offering a corresponding bid price, a number, etc. is organized in the form of a table, and is disclosed to all buyers.

Next, a bid process and a successful bid process will be described in detail.

After products for an auction are prepared in accordance with the embodiment of the present invention, a bid notification is performed through an online or offline mode before the biding is performed. Thus, the buyers access the mediation system 2 through various channels to join the bid.

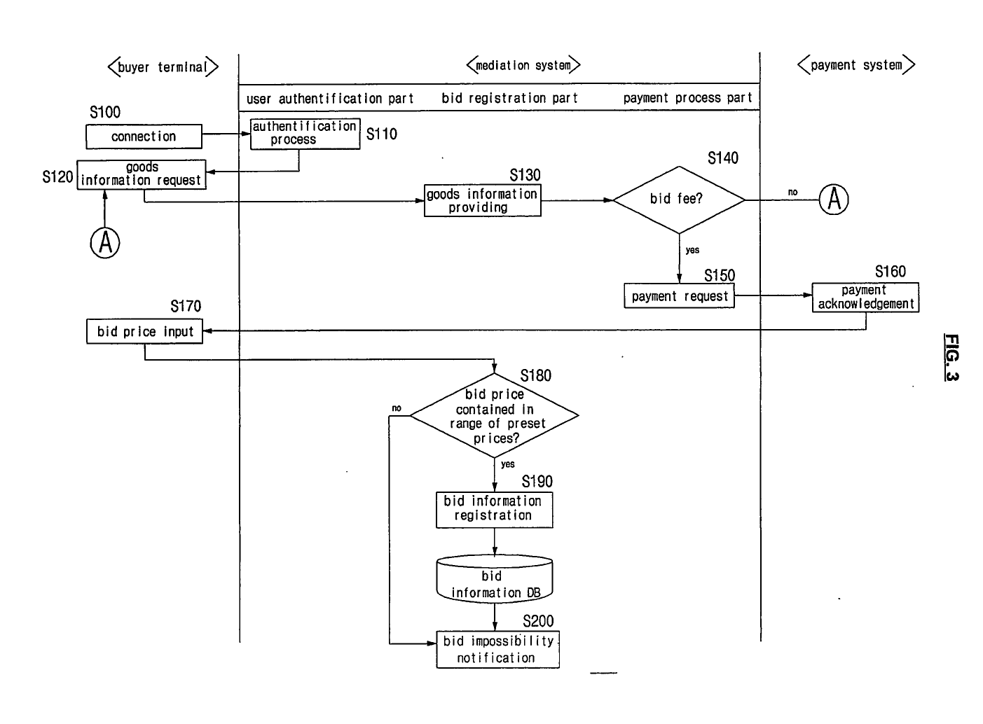

FIG. 3 is a flowchart illustrating a process for registering a bid through the Internet in the auction service operating system in accordance with the embodiment of the present invention. As shown in FIG. 3, when a buyer inputs a uniform resource locator (URL) for accessing the mediation system 2 in a state in which a program for a network connection is started through the buyer terminal 3, information of the URL is converted into a format based upon the hypertext transfer protocol (HTTP) by a web browser. After the information is packetized, the packetized information is transmitted to the mediation system 2 through the network 1.

The interface server 10 included in the mediation system 2 sends a web page corresponding to the URL information to the buyer terminal 3. The sent web page is converted into a window state on the web browser, and then the converted web page is displayed. Thus, the buyer confirms various information units provided by the mediation system 2 through the web page displayed on the terminal 3 (S100).

Then, the interface server 10 included in the mediation system 2 provides a view necessary for authenticating a member of the buyer terminal 3. If a buyers ID and password, etc. are received from the buyer terminal 3, the user authentication part 310 included in the process server 30 performs a member authentication procedure according to whether the buyers ID and password, etc. are stored in the membership information database 425 (S110). If a buyer authenticated or not authenticated as a member makes a product information request, the bid registration part 320 included in the process server 30 couples the buyer terminal 3 to a web page providing corresponding product information, and allows the buyer to confirm bid product information (S120 and S130). Here, various product information units are provided on a category-by-category basis, for example, communication equipment, sound equipment, beauty goods, household goods, health goods, etc. Information units associated with a goods code of each product, the highest and lowest prices, the existence of a bid fee, etc. are provided, such that the buyer can decide an appropriate bid price.

Where a buyer selects a specific product and joins the bid, the payment process part 340 determines whether the bid fee is present, and the payment system 4 makes a payment request to process payment if the bid fee is present (S140 to S160). When the buyer inputs a bid price after the payment has been completed, the bid registration part 320 determines whether the bid price is contained within a set range, i.e., a range between the lowest and highest prices, and stores information of the bid price and buyer in the bid information database 422 if the bid price is contained within the range between the lowest and highest prices (S170 to S190). On the other hand, if the bid price is not contained within the range between the lowest and highest prices, the buyer terminal 3 is notified of the fact that a bid associated with a corresponding product is not possible (S200). Furthermore, if the bid fee associated with the bid product is not present as a result of the determination at the above step S140, the bid registration part 320 stores and registers the bid information containing a bid price of the buyer in the bid information database 422 without a separate payment process.

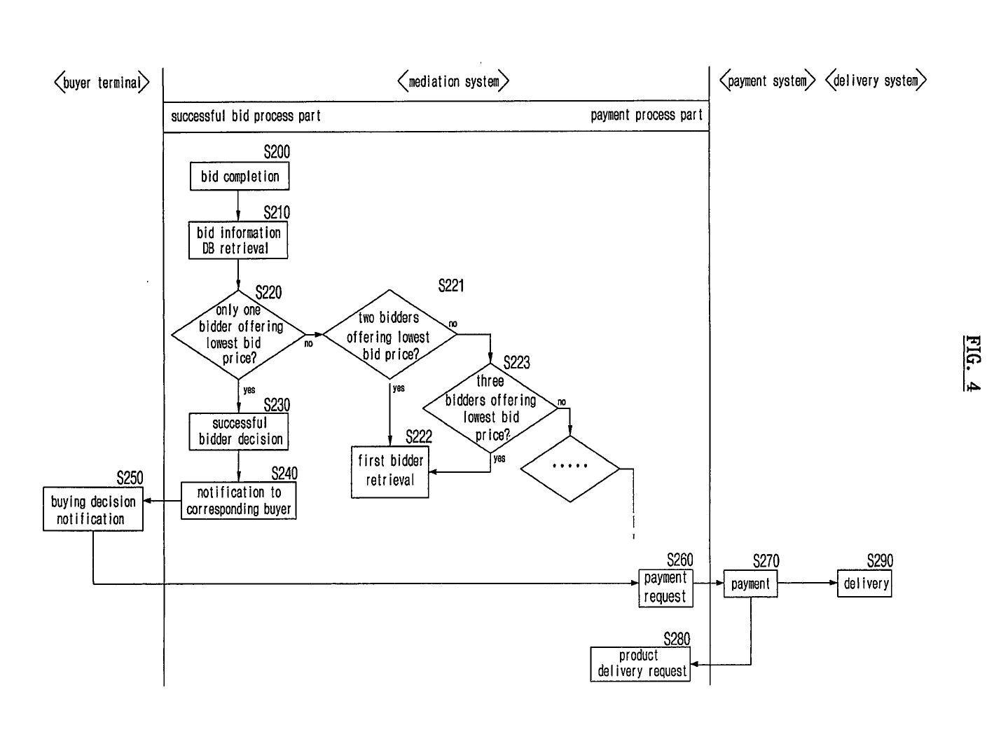

Then, the mediation system 2 carries out the successful bid process on the basis of the bid information stored in the bid information database 422. The successful bid process will be described with reference to FIG. 4. As shown in FIG. 4, the successful bid process part 330 determines whether a preset bid time (e.g., 3 minutes, 5 minutes or etc.) has elapsed. If the bid time has expired, the successful bid process is carried out on the basis of the bid information stored in the bid information database 422. That is, a plurality of bid information units stored according to goods codes are retrieved from the bid information database 422 (S200). If there is only one buyer offering the lowest bid price within the bid price range designated by the auction operator, the buyer is selected as a successful bidder (S220 and S230). As soon as the time limit expires, the successful bidder is selected and decided.

On the other hand, if one buyer offering the lowest bid price is not present, but at least two bidders offering the lowest bid price are present, the first bidder offering the lowest bid price is decided to be the successful bidder. A process for selecting the successful bidder will be described in the following.

1. When the bid time has expired, bid prices are arranged in ascending order.

2. A bid price offered by only one bidder joining the bid is retrieved from the bid prices, and a re-arrangement operation is carried out.

3. A bidder offering the lowest bid price is selected as the successful bidder, and the successful bidder can buy a corresponding product at his/her bid price.

If the lowest bid price is equally offered by at least two bidders, the successful bidder is selected according to the following order.

4. A bid price equally offered by only two bidders is selected, and a re-arrangement operation is carried out in ascending order.

5. If a bid price equally offered by only two bidders is not present, a bid price equally offered by the next minimum number of bidders, i.e., only three bidders or only four bidders, is selected, and a re-arrangement operation is carried out in ascending order. A buyer first offering the lowest bid price among a plurality of bidders is selected as the successful bidder.

If an auction service is operated as described above, a final successful bidder is necessarily decided. The case where the successful bidder is not decided is only the case where no bidder joins an auction for a product.

If the successful bidder is selected on a product-by-product basis as described above, the successful bid process part 330 notifies a corresponding buyer terminal 3 of the successful bid through the mail server 50, etc.

The buyer notified of the successful bid provides a final buying decision to the mediation system 2. If the buyer desires to buy a product based upon the successful bid, the payment process part 340 provides information indicative of an amount of money and payment information corresponding to the bid price offered by the buyer to the payment system 4 so that the payment system 4 can carry out payment in response to a payment request (S250 to S270). If the payment system 4 has carried out the payment, an amount of payment, a payment date, a payment number, etc. are stored in the payment information database 424. Information of the delivery system for delivering a corresponding product is retrieved from the goods information database 421, information units associated with a code of the product to be delivered, a delivery place, a delivery date, etc. are provided to a corresponding delivery system 5 so that the delivery system 5 can deliver the product in response to a delivery request (S280 and S290). Here, the delivery system 5 can be a supplier for supplying the product or a delivery company for receiving a product from the supplier to deliver the received product.

As apparent from the above description, the present invention provides an operating system and method for use in an auction service based upon the lowest bid price that are characterized in that buyer information and bid price information are disclosed in real time. An original object of the auction is to decide a bidder offering a bid price higher than other bid prices of other bidders (or less than other bid prices of other bidders in a reverse auction) to be a successful bidder. However, the existing auction method based upon the lowest bid price has various problems in that bid prices of other bidders are not disclosed in real time and hence it is difficult for a bidder to appropriately select a bid price. The present invention enables each bidder to perform a bid while confirming bid prices of other bidders, because the bid information is disclosed in real time. Furthermore, if the bid end time is limited to a predetermined time (e.g., 3 minutes, 5 minutes, etc.), and bidders (buyers) can confirm a bid state in real time, it seems that a bidder quickly offering a bid price is disadvantageous, but an operation for first offering a bid price can be strategically utilized and bidders (buyers) can strategically join an auction.

Although the preferred embodiments of the present invention have been disclosed for illustrative purposes, those skilled in the art will appreciate that various modifications, additions and substitutions are possible, without departing from the scope of the invention. Accordingly, the present invention is not limited to the above-described embodiments, but the present invention is defined by the claims which follow, along with their full scope of equivalents.

1. An auction service operating system based upon a lowest bid price, the auction service operating system being connected to a plurality of buyer terminals through at least one network and deciding one buyer offering the lowest bid price within a range between predetermined highest and lowest prices on a product to be a successful bidder for a predetermined time, comprising:
a goods information database for storing goods information containing highest and lowest prices according to goods codes in an auction;
a bid information database for storing bid information containing bid price and bidder information according to the goods codes;
a bid registration part for carrying out a bid registration process by storing received bid prices in the bid information database when the bid prices are provided from the buyer terminals; and
a successful bid process part for retrieving the lowest bid price from the bid information about a specific product stored in the bid information database, and deciding a buyer offering the lowest bid price to be a successful bidder if the lowest bid price is contained between the predetermined highest and lowest prices,
wherein the bid prices offered by buyers are disclosed for a predetermined bid time.

2. An auction service operating method based upon a lowest bid price in a system being connected to a plurality of buyer terminals through at least one network and deciding one buyer offering the lowest bid price within a range between predetermined highest and lowest prices on a product to be a successful bidder for a predetermined time, comprising the steps of:
(a) allowing buyers (or bidders) to select an auction product and to access the system;
(b) allowing the buyers to offer bid prices within the predetermined highest and lowest prices; and
(c) when a predetermined bid time expires, deciding a buyer (or bidder) offering the lowest bid price to be a successful bidder,
wherein the bid prices offered by the buyers are disclosed for the bid time.

3. The auction service operating method based upon the lowest bid price as set forth in claim 2, further comprising the step of:
when only one bidder offering the lowest bid price is not present at the step ©), carrying out a retrieving operation to determine whether at least two bidders offering the lowest bid price are present, and deciding one of the at least two bidders first offering the lowest bid price to be the successful bidder.
